(19) United States
(12) Patent Application Publication
(10) Pub. No.: US 2023/0339041 A1
(43) Pub. Date: Oct. 26, 2023

(54) POLYMERIC REDUCTION MATERIAL FOR GAS PRESSURE WELDING AND GAS PRESSURE WELDING METHOD

(71) Applicant: Murayoshi Gas Pressure Welding Industry Co., Ltd., Okinawa (JP)

(72) Inventor: Seiyu MURAYOSHI, Okinawa (JP)

(73) Assignee: Murayoshi Gas Pressure Welding Industry Co., Ltd., Okinawa (JP)

(21) Appl. No.: 18/011,531

(22) PCT Filed: Nov. 4, 2021
(86) PCT No.: PCT/JP2021/040664

§ 371 Date: Dec. 20, 2022

(30) Foreign Application Priority Data
Dec. 7, 2020 (JP) 2020-202985

(51) Int. Cl. B23K 20/14

(52) U.S. Cl. CPC B23K 20/14

(57) ABSTRACT

A polymeric reduction material for gas pressure welding A1 includes a cap body 1 that is made of a thermoplastic resin, can be externally fitted to a pressure welded-side end portion of the material to be pressure welded, and is a bottomed cylindrical body, an air blocking ring 2 that is integrally provided at a bottom portion 12 of the cap body 1, is made of a thermosetting resin, and has a required diameter, a reduction sheet 3 that sandwiches the air blocking ring 2 between the bottom portion 12 of the cap body 1 and the reduction sheet 3, has a diameter equal to or larger than that of the air blocking ring 2, and is made of a thermoplastic resin. A reduction ring 5 made of a polyimide resin is wound around an outer peripheral portion of a stacked portion of the reduction sheet.

### BACKGROUND

### Field of the Invention

The present invention relates to a polymeric reduction material for gas pressure welding and a gas pressure welding method. More specifically, the present invention relates to a polymeric reduction material for gas pressure welding and a gas pressure welding method which allow heating with a standard flame from an initial stage of heating so as to obtain sufficient thermal power even in the case of using natural gas, propane gas, hydrogen gas, or the like, which is inferior in thermal power to acetylene gas, in performing gas pressure welding of reinforcing bars or the like, and which can suppress the formation of residue on a pressure welded part to allow pressure welding with sufficient strength.

### Background Art

In gas pressure welding of reinforcing bars using acetylene gas, for example, it is necessary to polish pressure welded surfaces of the reinforcing bars and heat them with a reducing flame in initial heating until tip surfaces thereof are brought into close contact with each other. If the initial heating is performed with a standard flame (neutral flame or oxidizing flame), an oxide film is formed on the pressure welded surface, resulting in poor bonding, and a fracture at the pressure welded part (pressure welded surface fracture) occurs.

On the other hand, the use of natural gas or propane gas, which is inferior in thermal power compared with acetylene gas but is easy to handle and has a small environmental load, has long been a concern. That is, when the pressure welding is attempted using these gases, it is necessary to heat with a standard flame from the initial heating in order to obtain a thermal power equal to that of acetylene gas. In this case, a measure to suppress the formation of the oxide film at the pressure welded part is required.

As one of the measures, a gas pressure welding method (Ecospeed Method) described in Non-Patent Literature 1 has been proposed. In this pressure welding method, a cap-shaped PS ring in which a polystyrene sheet and a steel ring are fitted is used as a reduction material (or antioxidant material) when the reinforcing bars or the like are pressure welded.

The polystyrene sheet and the steel ring of the PS ring are sandwiched between the tip surfaces of the reinforcing bars to be pressure welded and are heated by the thermal power of natural gas to form a reducing atmosphere in the vicinity of the pressure welded surfaces by the reducing gas generated thereby, and the intrusion of atmospheric air into the pressure welded part is blocked by the steel ring to prevent oxidation, as a result of which the formation of the oxide film is suppressed.

### CITATION LIST

### Non-Patent Documents

Non-Patent Document 1: Website of ECOWEL Association searched on Nov. 18, 2020, http://ecowel.com/Industrial%20method%20es/1.Industrial%20m ethod%20es%20Feature/es%20Feature.html

### SUMMARY OF THE INVENTION

### Technical Problems

However, the gas pressure welding method described in Non-Patent Literature 1 has the following problems. That is, in this gas pressure welding method, it is said that the formation of an oxide film on the pressure welded surface can be suppressed, that even if a standard flame is used from the initial heating, poor bonding is unlikely to occur, and that the type of heating gas does not matter. However, since the steel ring is fitted into the PS ring together with the polystyrene sheet, a ring-shaped metal (made of steel) different from the base material (reinforcing bar) remains on the pressure welded surface after the pressure welding is completed.

Therefore, the metal made of steel is present while being sandwiched between the pressure welded surfaces of the reinforcing bars, and this may inhibit the mechanism of pressure welding, “the phenomenon in which atoms are metal bonded to be integrated by diffusing across the pressure welded surfaces during the pressure welding.” The possibility that the strength of the pressure welded part is thus insufficient to cause a pressure welding surface fracture cannot be excluded.

The present invention has been made in view of the above points, and an object thereof is to provide a polymeric reduction material for gas pressure welding and a gas pressure welding method which allow heating with a standard flame from an initial stage of heating so as to obtain sufficient thermal power even in the case of using natural gas, propane gas, hydrogen gas, or the like, which is inferior in thermal power to acetylene gas, in performing gas pressure welding of reinforcing bars or the like, and which can suppress the formation of residue on a pressure welded part to allow pressure welding with sufficient strength.

### Solution to Problems

(1) In order to achieve the above object, a polymeric reduction material for gas pressure welding according to the present invention includes an air blocking ring that can be arranged between pressure welded surfaces of materials to be pressure welded, is made of a thermosetting resin, and has a required diameter, a reduction sheet that is stacked so as to be positioned on one side of the air blocking ring or stacked so as to sandwich the air blocking ring from both front and rear sides, and has a diameter equal to or larger than that of the air blocking ring and is made of a thermoplastic resin, and a string-shaped or band-shaped reduction ring that is wound apart from the air blocking ring around an outer peripheral portion on substantially the same plane as a stacked portion of the air blocking ring and the reduction sheet and is made of a thermosetting resin.

The polymeric reduction material for gas pressure welding of the present invention can be arranged between the pressure welded surfaces of the materials to be pressure welded and is heated together with the materials to be pressure welded while being sandwiched between the tip surfaces, whereby the pressure welding can be firmly performed while suppressing the formation of an oxide film on the pressure welded surface.

That is, by including the air blocking ring that is made of a thermosetting resin and has a required diameter, the reduction sheet that is stacked so as to be positioned on one side of the air blocking ring or stacked so as to sandwich the air blocking ring from both front and rear sides, has a diameter equal to or larger than that of the air blocking ring, and is made of a thermoplastic resin, and the string-shaped or band-shaped reduction ring that is wound apart from the air blocking ring around an outer peripheral portion on substantially the same plane as the stacked portion of the air blocking ring and the reduction sheet, and is made of a thermosetting resin, the reduction sheet is first melted and burned by being heated by the flame of the gas in the pressure welding operation.

The reduction sheet is melted, burned, and further vaporized to rapidly increase in volume in a very short time within a slight gap sandwiched between the tip surfaces of the materials to be pressure welded inside the air blocking ring made of a thermosetting resin and not yet melted. As a result, the air in the gap inside the air blocking ring is pushed out to the outside at a high pressure, and oxygen in the air is combined with carbon of the polymer to become carbon dioxide gas, and oxidation around the pressure welded part 400 is suppressed.

While the air blocking ring is not melted, the intrusion of the air into the gap inside the air blocking ring is blocked. Combined therewith, oxidation within the gap is suppressed, and the formation of an oxide film on the pressure welded surface (tip surface on the pressure welded-side) can be suppressed.

As just described, according to the polymeric reduction material for gas pressure welding of the present invention, in the case of using natural gas, propane gas, hydrogen gas, or the like, which is inferior in thermal power to acetylene gas, in performing gas pressure welding of materials to be pressure welded, the formation of residue such as an oxide film and a metal residue on the pressure welded part can be suppressed even if heating is performed with a standard flame from the initial stage of heating so as to obtain sufficient thermal power, and pressure welding with sufficient strength can be performed.

Further, when the materials to be pressure welded are pressure welded, the pressure welded part can be substantially closed along outer peripheries of the pressure welded surfaces of the materials to be pressure welded in a state in which the reduction ring is heated and not melted. As a result, in a slight gap sandwiched between the tip surfaces of the materials to be pressure welded inside the air blocking ring, the reduction sheet is melted, burned, and further vaporized to rapidly increase in volume in a very short time, whereby the air in the gap inside the air blocking ring tries to be pushed out but is stopped by the reduction ring, and the internal pressure becomes extremely high.

Furthermore, the pushing out of the air to the outside when the air blocking ring is carbonized is instantaneously and explosively performed together with carbonation and fracture of the reduction ring. Therefore, oxygen in the air is combined with carbon of the polymer to become carbon dioxide gas, and the effect of suppressing oxidation around the pressure welded part is further enhanced.

The polymeric reduction material for gas pressure welding provided with the reduction sheet on both the front and rear sides of the air blocking ring has an advantage over the one using only the air blocking ring in that a flat fracture surface generated on the pressure welded surface is less likely to occur in a central portion of a fracture surface (the center in this case means the vicinity of the central portion of the cross section of the pressure welded part).

As for this advantage, given that a case in which the reduction sheet is provided on one side of the air blocking ring is considered as an intermediate positioning of both cases of the above pressure welding fracture test, it can be assumed that the case in which the reduction sheet is provided on both the front and rear sides of the air blocking ring results in a favorable result as compared with the case in which the reduction sheet is provided on one side of the air blocking ring. Thus, it can be said that the polymeric reduction material for gas pressure welding is more preferably provided with the reduction sheet on both the front and rear sides of the air blocking ring.

(2) In order to achieve the foregoing object, the polymeric reduction material for gas pressure welding according to the present invention may be configured to include a cap body that is made of a thermoplastic resin, can be externally fitted to a pressure welded-side end portion of the material to be pressure welded, and is a bottomed cylindrical body, wherein the air blocking ring is integrally provided at a bottom portion of the cap body.

In this case, the polymeric reduction material for gas pressure welding is provided with the cap body, so that the cap body is externally fitted to the pressure welded-side end portion of the material to be pressure welded, and the air blocking ring and the reduction sheet can be arranged between the pressure welded surfaces of the materials to be pressure welded, and the polymeric reduction material for gas pressure welding is heated together with the materials to be pressure welded while being sandwiched between the tip surfaces, whereby pressure welding can be firmly performed while suppressing the formation of an oxide film on the pressure welded surface.

That is, by including the air blocking ring that is made of a thermosetting resin and has a required diameter and the reduction sheet that sandwiches the air blocking ring between the bottom portion of the cap body, the reduction sheet has a diameter equal to or larger than that of the air blocking ring, and is made of a thermoplastic resin, the reduction sheet is first melted and burned by being heated by the flame of the gas in the pressure welding operation.

By arranging the air blocking ring made of a thermosetting resin such as polyimide resin on the pressure welded surface, an antioxidant effect in a part near the outer peripheral portion of the pressure welded surface can be expected. By arranging the reduction sheet made of a thermoplastic resin such as polystyrene on almost an entire surface of the pressure welded surface, an antioxidant effect in a part inside the air blocking ring of the pressure welded surface can be expected.

(3) The polymeric reduction material for gas pressure welding according to the present invention may be configured such that the air blocking ring is formed in a spiral shape in which both end portions are overlapped on inner and outer sides by a predetermined length.

In this case, since the air blocking ring has a spiral shape in which both end portions are overlapped on the inner and outer sides by a predetermined length, it can be assumed that, in a situation where the air blocking ring is sandwiched between the pressure welded surfaces of the agents to be pressure welded at a specified pressure, the strength increases as compared with the air blocking ring of the polymeric reduction material for gas pressure welding and the timing at which the air blocking ring is heated and carbonized to be fractured is slightly delayed. That is, the pressure of the air blown out to the outside is further increased, and the effect of suppressing the oxidation around the pressure welded part is further enhanced.

(4) The polymeric reduction material for gas pressure welding may be configured such that the air blocking ring is made of a polyimide resin and the reduction sheet is made of a polystyrene resin.

In this case, the heat resistance performance of the air blocking ring made of a polyimide resin is 220° C., and reaches 400° C. if it is for a short time. Therefore, at the time of pressure welding, a predetermined hardness is sufficiently maintained until the pressure welded part is heated to the temperature. After the heat resistant temperature is exceeded, the air blocking ring is burned and carbonized at 800° C. However, the air blocking ring does not raise a flame during the burning, has a self-extinguishing property, and does not generate toxic gas, so that it is also excellent in terms of safety.

The heat resistance performance of the reduction sheet made of a polystyrene resin (including the bottom portion of the cap body) is 70 to 90° C. and the melting point is 100° C. Therefore, the reduction sheet is melted and burned to be vaporized in a very short time by being heated by the flame of the gas at the time of pressure welding. The reduction sheet is decomposed at 280° C. or higher, and does not generate toxic gas similar to the polyimide resin, so that the safety is high.

(5) The polymeric reduction material for gas pressure welding according to the present invention may be configured such that the reduction sheet has a total thickness of 0.17 to 2.55 mm.

In this configuration, when the total thickness of the reduction sheet made of a polystyrene resin is less than 0.17 mm, the amount as the reduction agent is insufficient, so that it tends to be useless in terms of suppressing the oxidation.

When the total thickness of the reduction sheet made of a polystyrene resin exceeds 2.55 mm, the tensile strength of the pressure welded part was significantly reduced. Thus, when the reduction sheet made of a polystyrene resin is too thick, the reduction sheet is likely to cause a fracture or a failure at the time of initial pressurization and is melted down at an early stage due to the weight of polystyrene, so that it tends to be useless in terms of suppressing the oxidation.

When the total thickness of the reduction sheet is set in the range of 1.7 to 2.55 mm, a predetermined fracture performance that does not cause a pressure welded surface fracture can be obtained. However, it is more preferable to set the total thickness in a range of 0.34 to 1.36 mm in order to increase the strength of the pressure welded part.

(6) In order to achieve the foregoing object, a gas pressure welding method according to the present invention includes a step of arranging a polymeric reduction material for gas pressure welding by stacking, between pressure welded surfaces of materials to be pressure welded, an air blocking ring that is made of a thermosetting resin and has a required diameter and a reduction sheet that is positioned on one side of the air blocking ring or sandwiches the air blocking ring from both front and rear sides, and has a diameter equal to or larger than that of the air blocking ring and is made of a thermoplastic resin, and by winding a string-shaped or band-shaped reduction ring made of a thermosetting resin apart from the air blocking ring around an outer peripheral portion on substantially the same plane of a stacked portion of the air blocking ring and the reduction sheet, and a step of heating a pressure welded part of the materials to be pressure welded by thermal power of a required gas while applying a predetermined pressure to each of the materials to be pressure welded in a direction in which pressure welded surfaces of the materials to be pressure welded are brought into close contact with each other.

In the gas pressure welding method according to the present invention, by the step of arranging the polymeric reduction material for gas pressure welding in which the air blocking ring that is made of a thermosetting resin and has a required diameter and the reduction sheet that is positioned on one side of the air blocking ring or sandwiches the air blocking ring from both the front and rear sides and that has a diameter equal to or larger than that of the air blocking ring and is made of a thermoplastic resin are stacked between the pressure welded surfaces of the materials to be pressure welded, the air blocking ring can be covered from one side or from both the front and rear sides of the air blocking ring by the reduction sheet, and a hollow portion of the air blocking ring can be closed by the reduction sheet, and the polymeric reduction material for gas pressure welding can be arranged between the pressure welded surfaces of the materials to be pressure welded in this state.

By the step of heating the pressure welded part of the materials to be pressure welded by thermal power of a predetermined gas while applying a predetermined pressure to each of the materials to be pressure welded in a direction in which the pressure welded surfaces of the materials to be pressure welded are brought into close contact with each other, the reduction sheet is first melted and burned by being heated by the flame of the gas in the pressure welding operation.

In a slight gap sandwiched between the tip surfaces of the materials to be pressure welded inside the air blocking ring made of a thermosetting resin and not yet melted, the reduction sheet is melted, burned, and further vaporized to rapidly increase in volume in a very short time, whereby the air in the gap inside the air blocking ring is pushed out to the outside at a high pressure, and oxygen in the air is combined with carbon of the polymer to become carbon dioxide gas, and oxidation of the surrounding is suppressed.

While the air blocking ring is not melted, the intrusion of the air into the gap inside the air blocking ring is blocked. Combined therewith, oxidation within the gap is suppressed, and the formation of an oxide film on the pressure welded surface can be suppressed.

Further, when the materials to be pressure welded are pressure welded, the pressure welded part can be substantially closed along outer peripheries of the pressure welded surfaces of the materials to be pressure welded in a state in which the reduction ring is heated and not melted. As a result, in the slight gap sandwiched between the tip surfaces of the materials to be pressure welded inside the air blocking ring, the reduction sheet is melted, burned, and further vaporized to rapidly increase in volume in a very short time, whereby the air in the gap inside the air blocking ring tries to be pushed out but is stopped by the reduction ring, and the internal pressure becomes extremely high.

Furthermore, the pushing out of the air to the outside when the air blocking ring is carbonized is instantaneously and explosively performed together with carbonation and fracture of the reduction ring. Therefore, oxygen in the air is combined with carbon of the polymer to become carbon dioxide gas, and the effect of suppressing oxidation around the pressure welded part is further enhanced.

As just described, according to the polymeric reduction material for gas pressure welding of the present invention, in the case of using natural gas, propane gas, hydrogen gas, or the like, which is inferior in thermal power to acetylene gas, in performing gas pressure welding of the materials to be pressure welded, the formation of residue such as an oxide film and a metal residue on the pressure welded part is suppressed even if heating is performed with a standard flame from the initial stage of heating so as to obtain sufficient thermal power, and pressure welding with sufficient strength can be performed.

According to the gas pressure welding method, the polymeric reduction material for gas pressure welding provided with the reduction sheet on both the front and rear sides of the air blocking ring has an advantage over the one using only the air blocking ring in that the flat fracture surface generated on the pressure welded surface is less likely to occur in the central portion of the fracture surface.

As for this advantage, given that the case in which the reduction sheet is provided on one side of the air blocking ring is considered as an intermediate positioning of both cases of the above pressure welding fracture test, it can be assumed that the case in which the reduction sheet is provided on both the front and rear sides of the air blocking ring results in a favorable result as compared with the case in which the reduction sheet is provided on one side of the air blocking ring. Thus, in the gas pressure welding method as well, it can be said that the polymeric reduction material for gas pressure welding is more preferably provided with the reduction sheet on both the front and rear sides of the air blocking ring.

(7) The gas pressure welding method according to the present invention may be configured such that the air blocking ring is formed in a spiral shape in which both end portions are overlapped on inner and outer sides by a predetermined length.

In this case, since the air blocking ring has a spiral shape in which both end portions are overlapped on the inner and outer sides by a predetermined length, it can be assumed that, in a situation where the air blocking ring is sandwiched between the pressure welded surfaces of the agents to be pressure welded at a specified pressure, the strength increases as compared with the air blocking ring of the polymeric reduction material for gas pressure welding and the timing at which the air blocking ring is heated and carbonized to be fractured is slightly delayed. That is, the pressure of the air blown out to the outside is further increased, and the effect of suppressing the oxidation around the pressure welded part is further enhanced.

(8) The gas pressure welding method according to the present invention may be configured such that the air blocking ring is made of a polyimide resin and the reduction sheet is made of a polystyrene resin.

In this case, similar to the polymeric reduction material for gas pressure welding of (4) above, the heat resistance performance of the air blocking ring made of a polyimide resin is 220° C., and reaches 400° C. if it is for a short time. Therefore, at the time of pressure welding, a predetermined hardness is sufficiently maintained until the pressure welded part is heated to the temperature. After the heat resistant temperature is exceeded, the air blocking ring is burned and carbonized at 800° C. However, the air blocking ring does not raise a flame during the burning, has a self-extinguishing property, and does not generate toxic gas, so that it is also excellent in terms of safety.

The heat resistance performance of the reduction sheet made of a polystyrene resin (including the bottom portion of the cap body) is 70 to 90° C. and the melting point is 100° C. Therefore, the reduction sheet is melted and burned to be vaporized in a very short time by being heated by the flame of the gas at the time of pressure welding. The reduction sheet is decomposed at 280° C. or higher, and does not generate toxic gas similar to the polyimide resin, so that the safety is high.

(9) The gas pressure welding method according to the present invention may be configured such that the gas is propane gas and heating is performed with a standard flame from an initial stage of heating.

In this case, since the propane gas is inferior in thermal power to the acetylene gas, it is necessary to perform heating with a standard flame from the initial stage of heating at the time of pressure welding of the materials to be pressure welded using the propane gas. In general, when heating is performed with a standard flame from the initial stage of heating, residue such as an oxide film tends to remain on the pressure welded surface, and this tends to cause the strength of the pressure welded part to become insufficient. However, according to the pressure welding method of the present invention, sufficient strength of the pressure welded part can be obtained by inhibiting the residue such as an oxide film from remaining.

### Advantageous Effects of Invention

The present invention can provide a polymeric reduction material for gas pressure welding and a gas pressure welding method which allow heating with a standard flame from an initial stage of heating so as to obtain sufficient thermal power even in the case of using natural gas, propane gas, hydrogen gas, or the like, which is inferior in thermal power to acetylene gas, in performing gas pressure welding of reinforcing bars or the like, and which can suppress the formation of residue on a pressure welded part to allow pressure welding with sufficient strength.

### BRIEF DESCRIPTION OF THE DRAWINGS

FIG. 1 is a perspective view showing a first embodiment of a polymeric reduction material for gas pressure welding according to the present invention.

FIG. 2 is a longitudinal sectional view of the polymeric reduction material for gas pressure welding shown in FIG. 1.

FIG. 3 is an explanatory diagram showing a step of gas pressure welding using the polymeric reduction material for gas pressure welding shown in FIG. 1.

FIG. 4 is an explanatory diagram in which gas pressure welding of deformed reinforcing bars has been performed by a gas pressure welding method according to the present invention and each test piece has been notched and fractured to verify a flat fracture surface.

FIG. 5 is an explanatory diagram in which gas pressure welding of deformed reinforcing bars has been performed by a gas pressure welding method using an air blocking ring made of a polyimide resin as an antioxidant means and each test piece has been notched and fractured to verify a flat fracture surface.

FIG. 6 is a perspective view showing a second embodiment of a polymeric reduction material for gas pressure welding according to the present invention.

FIG. 7 is a longitudinal sectional view of the polymeric reduction material for gas pressure welding shown in FIG. 6.

### DESCRIPTION OF THE EMBODIMENTS

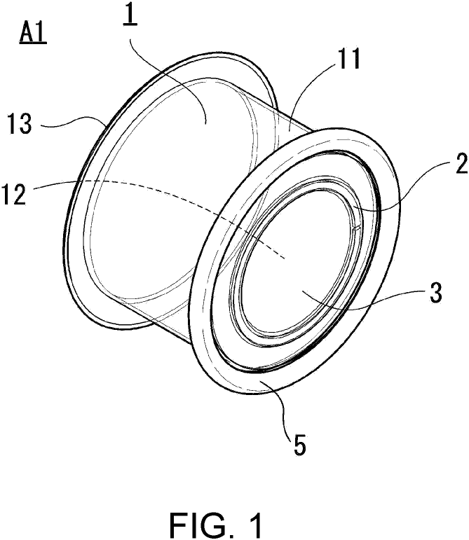

Embodiments of the present invention will be described in more detail with reference to FIG. 1 to FIG. 7.

A polymeric reduction material for gas pressure welding A1 according to the present invention suppresses the formation of an oxide film on a pressure welded surface by performing a pressure welding operation while being sandwiched between pressure welded surfaces of materials to be pressure welded such as deformed reinforcing bars.

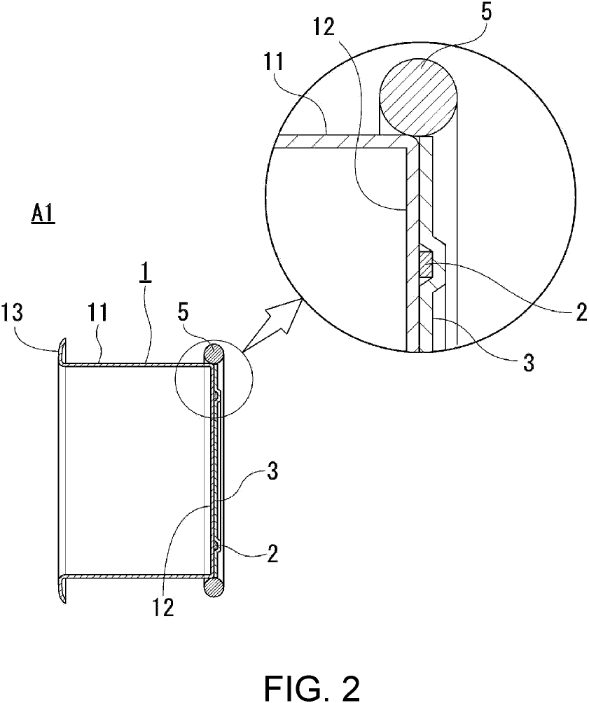

Reference is made to FIG. 1 and FIG. 2.

The polymeric reduction material for gas pressure welding A1 has a cap body 1. The cap body 1 is made of a sheet made of a polystyrene resin, which is a thermoplastic resin, and is composed of a cylindrical portion 11 and a bottom portion 12 which is a circular reduction sheet closing a proximal end portion of the cylindrical portion 11. A tip portion of the cylindrical portion 11 is provided with a flange 13 to reinforce the cylindrical portion 11 so as to be less likely to deform over the entire circumference.

Further, an air blocking ring 2 made of a polyimide resin, which is a thermosetting resin, is arranged on an outer surface of the bottom portion 12, and a circular reduction sheet 3 having a diameter slightly larger than that of the air blocking ring 2 and made of a polystyrene resin is welded with the air blocking ring 2 sandwiched between the bottom portion 12 and the reduction sheet 3.

The reduction sheet 3 is thermally deformed so as to be substantially along the outline of the air blocking ring 2 and cooperates with the bottom portion 12 to enclose the air blocking ring 2 (see the enlarged view of FIG. 2). A reduction ring 5 made of a polyimide resin is wound around an outer peripheral portion of a stacked portion of the air blocking ring 2, the bottom portion 12, and the reduction sheet 3.

It is noted that the air blocking ring 2 is circular in the present embodiment, but is not limited thereto, and for example, a ring-shaped (annular) one having a so-called irregular shape such as a polygon, an ellipse, a star, and a gear can be employed.

Furthermore, the shape of the reduction sheet 3 is also not limited to the circular shape, and various other shapes can be employed as long as a sufficient space can be secured inside the air blocking ring 2. The “diameter” in the terms “the same diameter” and “large diameter” in the present invention is used to mean not only the distance across a circle but also the distance across an ellipse, various polygons, etc., in addition to the circle.

The inner diameter of the cylindrical portion 11 of the cap body 1 is formed to have an appropriate size so as not to have looseness, difficulty in insertion, etc., in accordance with the outer diameter of the deformed reinforcing bar or the like to be the material to be pressure welded. When the cap body 1 is fitted into the material to be pressure welded, the air blocking ring 2 fits in the center of the pressure welded surface of the material to be pressure welded and the bottom portion 12 abuts against the pressure welded surface.

The thickness of the air blocking ring 2 is set to 2.25 mm in the present embodiment but can be adjusted as appropriate. The thickness of the bottom portion 12 and the reduction sheet 3 is 0.17 mm each and 0.34 mm when being stacked, in the present embodiment. When the total thickness of the reduction sheet is set in a range of 0.17 to 2.55 mm, a predetermined fracture performance can be obtained. However, it is more preferable to be set in a range of 0.34 to 1.36 mm.

The heat resistance performance of the air blocking ring 2 made of a polyimide resin is 220° C., and reaches 400° C. if it is for a short time. The air blocking ring 2 is carbonized at 800° C., does not raise a flame during the burning, has a self-extinguishing property, and does not generate toxic gas. Thus, it is also excellent in terms of safety. The heat resistance performance of the reduction sheet 3 made of a polystyrene resin is 70 to 90° C. and the melting point is 100° C. The reduction sheet 3 is decomposed at 280° C. or higher and does not generate toxic gas, so that the safety is high.

The material of the cap body 1 of the polymeric reduction material for gas pressure welding A1 is not limited to the polystyrene resin, and various resins can be appropriately employed as long as it is a thermoplastic resin such as polyethylene (PE) or polypropylene (PP). The material of the air blocking ring 2 is not limited to the polyimide resin, and various resins can be appropriately employed as long as it is a thermosetting resin such as silicon.

### Operation of Polymeric Reduction Material for Gas Pressure Welding A1

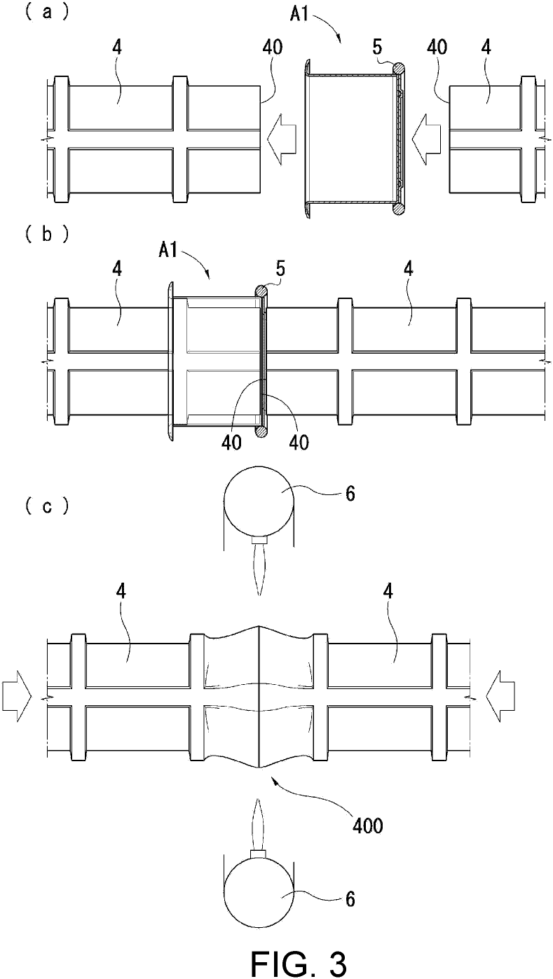

Referring to FIG. 3, the use and operation of the gas pressure welding method according to the present invention and the polymeric reduction material for gas pressure welding A1 according to the present embodiment will be described. The heating gas used in the gas pressure welding method is propane gas.

Propane gas has advantages that, similar to natural gas, the thermal power is weak as compared with acetylene gas but the environmental load (CO₂ emissions etc.) is small, it is easily available even in an isolated island or remoted area, and it is easy to handle due to its low risk.

In the present embodiment, the pressure welding of deformed reinforcing bars 4 will be described as an example. However, the polymeric reduction material for gas pressure welding A1, together with a polymeric reduction material for gas pressure welding A2 described later, can also be used for pressure welding (joining) of various rails, thick pipes, etc., in addition to such bar steels.

[1] Two deformed reinforcing bars 4 to be pressure welded are prepared. A pressure welded surface 40 of each deformed reinforcing bar 4 is polished and finished. The cylindrical portion 11 of the polymeric reduction material for gas pressure welding A1 is fitted into a tip portion of one deformed reinforcing bar 4 and is pushed into the deep part. As a result, the air blocking ring 2 fits in the center of the pressure welded surface 40 of the deformed reinforcing bar 4 and the bottom portion 12 abuts against the tip surface (see FIG. 3(a) and FIG. 3(b)).

[2] Next, both the deformed reinforcing bars 4 are held on the same central axis by a hydraulic pressure welding holder (not shown) and are brought into contact with each other in such a manner as to sandwich the bottom portion 12 of the cap body 1 and the reduction sheet 3 of the polymeric reduction material for gas pressure welding A1 together with the air blocking ring 2 enclosed therein between the pressure welded surface 40 of the deformed reinforcing bar 4 attached with the polymeric reduction material for gas pressure welding A1 and the pressure welded surface 40 of the other deformed reinforcing bar 4 (see FIG. 3(b)).

[3] A gas burner 6 is positioned at a specified position around the axis of a pressure welded part 400 of both the deformed reinforcing bars 4, and the deformed reinforcing bars 4 are pressed against each other at the pressure welded part with a specified pressure by the pressure welding holder. Propane gas is then used as the heating gas, and the pressure welded part is heated by a standard flame (neutral flame or oxidizing flame) from the initial stage of heating. At this time, the reduction ring 5 is also heated together.

[4] As a result, the pressure welded part 400 of the deformed reinforcing bars 4 is burned red to be a red-hot iron state, the pressure welded part 400 is gradually deformed by pressure to increase in diameter, atoms of the pressure welded surfaces 40 are diffused across the pressure welded surfaces 40 to be metal-bonded, and the pressure welded surfaces 40 are integrated without being melted (see FIG. 3(c)). By this time, the pressure of the pressure welded surfaces 40 is weakened, so that the pressure welding holder is further manually operated to adjust the pressure of the pressure welded surfaces 40 to increase.

Between the pressure welded surfaces 40, the bottom portion 12 and the reduction sheet 3 made of a polystyrene resin, which is a thermoplastic resin, become high in temperature, are melted, burned, and vaporized in a very short time to rapidly increase in volume in a slight gap (reference sign omitted) inside the air blocking ring 2 made of a thermosetting resin and not yet melted. As a result, the pressure of the air in the gap inside the air blocking ring 2 is increased.

At the time of pressure welding of the deformed reinforcing bars 4, the pressure welded part 400 can be substantially closed along outer peripheries of the pressure welded surfaces 4 of the deformed reinforcing bars 4 in a state where the reduction ring 5 is heated and not melted. As a result, in the slight gap sandwiched between the pressure welded surfaces 40 of the deformed reinforcing bars 4 inside the air blocking ring 2, the bottom portion 12 and the reduction sheet 3 are melted and burned in a very short time.

The bottom portion 12 and the reduction sheet 3 are vaporized by burning to rapidly increase in volume, whereby the air in the gap inside the air blocking ring 2 tries to be pushed out but is stopped by the reduction ring 5, and the internal pressure becomes extremely high. The pushing out of the air to the outside when the air blocking ring 2 is carbonized is instantaneously and explosively performed together with carbonation and fracture of the reduction ring 5. Oxygen in the air is combined with carbon of the polymer to become carbon dioxide gas, and the effect of suppressing oxidation around the pressure welded part 400 is further enhanced.

Heat is transferred from the pressure welded part 400 to an internal direction, but a temperature difference occurs between the center portion and the surface portion. For example, when only a thermoplastic resin having a low melting point is used as the reduction sheet, the burning of the reduction sheet disappears at a place near the surface portion by the time when the temperature of the center portion of the deformed reinforcing bar 4 rises, and the reduction sheet does not serve as oxidation suppression.

Accordingly, a polymer resin, such as polyimide, having a high heat resistance and a high antioxidant effect is preferred in a portion near the outer peripheral portion of the surface of the deformed reinforcing bar 4. However, when only a high heat-resistant resin is used, an incompletely burned soot-like residue remains in the center portion of the pressure welded surface 40 without being discharged to the outside, and this causes a reduction in strength (in particular, fatigue strength) of the pressure welded part 400.

Further, while the air blocking ring 2 is not melted yet, the intrusion of the air into the gap inside the air blocking ring 2 is blocked. Combined therewith, the formation of an oxide film on the pressure welded surface 40 can be suppressed.

As just described, according to the polymeric reduction material for gas pressure welding A1 of the present invention, in the case of using natural gas, propane gas, hydrogen gas, or the like, which is inferior in thermal power to acetylene gas, in performing gas pressure welding of the materials to be pressure welded such as the deformed reinforcing bars 4, the formation of residue such as an oxide film and a metal residue on the pressure welded surface 40 is suppressed even if heating is performed with a standard flame from the initial stage of heating so as to obtain sufficient thermal power, and pressure welding with sufficient strength can be performed.

### Pressure Welding Fracture Test 1

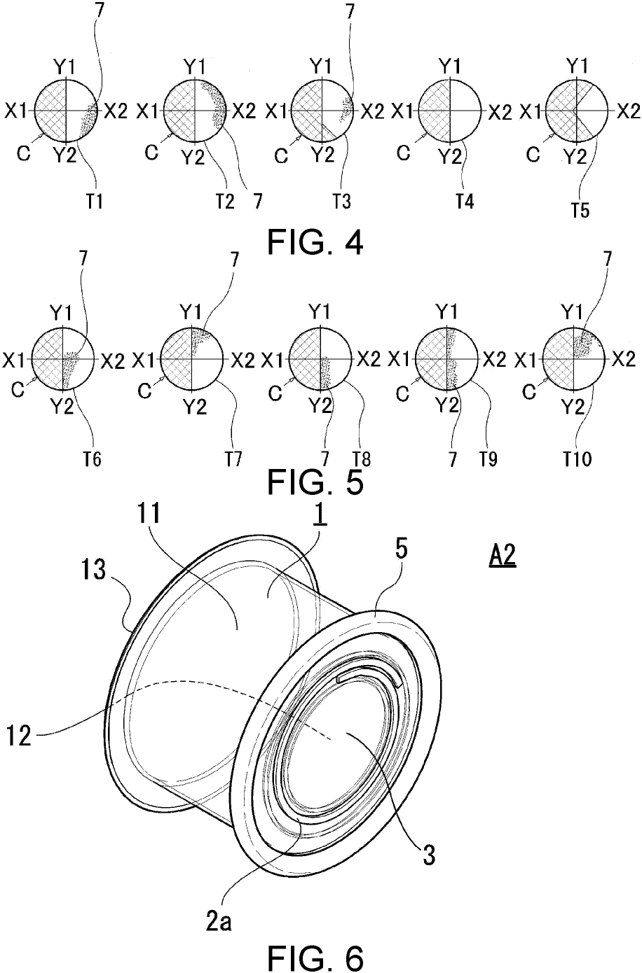

Next, a pressure welding fracture test 1 will be described with reference to FIG. 4. In the pressure welding fracture test 1, gas pressure welding of the deformed reinforcing bars 4 was performed by the gas pressure welding method using the polymeric reduction material for gas pressure welding A1 according to the present invention shown in FIG. 1 and FIG. 2, and the deformed reinforcing bars 4 were notched and fractured to prepare test pieces T1 to T5, and a flat fracture surface 7 generated on a fracture surface of each test piece was verified.

In each of the pressure welding fracture tests below, the size and position of the flat fracture surface generated on the fracture surface are the requirements for verification. The flat fracture surface is a fracture surface on which there are many specific oxides, has an appearance like a smoothed fracture surface, and is one of internal defects of a solid metal material.

Because the cause of occurrence of the flat fracture surface is complicated, it is not easy to identify the cause. However, the oxide residue on the flat fracture surface or the pressure welded surface may occur, for example, even if there is a slight defect that cannot be called an error in individual pressure welding operations.

As just described, when a flat fracture surface is generated for some reason, a large oxide or a dense group of oxides is formed on the pressure welded surface of the material to be pressure welded, a region in which metal bonding is not formed on the pressure welded surface increases, and the fatigue strength as the pressure welded material is reduced. In particular, when a large number of flat fracture surfaces are generated in the central portion of the material, it is said that this is especially conspicuous.

In the pressure welding fracture test 1 shown in FIG. 4, the flat fracture surface 7 was generated on the fracture surface of each of the test pieces T1, T2, T3 except the test pieces T4, T5. In the following description, the expressions of the front, the rear, the top, and the bottom are based on the directions shown in FIG. 4. That is, they are the front (X1), the rear (X2), the top (Y1), and the bottom (Y2), and the same applies to FIG. 5 showing a pressure welding fracture test 2 described later.

First, the flat fracture surface 7 generated on the test piece T1 in which a cut portion C has a half-moon shape was observed at a rear edge portion from a lower portion to partially an upper portion of the fracture surface excluding the cut portion C and was not observed in the vicinity of the central portion of the material. The flat fracture surface 7 generated on the test piece 2 in which the cut portion C similarly has a half-moon shape was observed at the rear edge portion from substantially the entire circumference of the upper portion of the fracture surface to partially an upper portion of the lower portion and was not observed in the vicinity of the central portion of the material.

Furthermore, the flat fracture surface 7 generated on the test piece T3 in which the cut portion C has substantially a half-moon shape and a part thereof entered the lower portion of the fracture surface was observed in the vicinity of the rear edge portion of a boundary portion between the upper and lower portions of the fracture surface and was not observed in the vicinity of the central portion of the material. As just described, in these test pieces T1, T2, T3, there was no flat fracture surface 7 that covered the vicinity of the central portion of the material, and the flat fracture surfaces 7 were all positioned near the outer peripheral edge portion of the fracture surface.

The test piece T4 was tested with the cut portion C in a half-moon shape, and the test piece T5 was tested with the cut portion C occupying about three quarters in the circumferential direction of the material by making a cut from two directions, but no flat fracture surface 7 was observed on the fracture surface.

### Discussion

For test pieces T1 to T5, considering the point that the flat fracture surface 7 was not observed on the fracture surface (test pieces T4, T5) or was not observed in the central portion of the fracture surface (in the vicinity of the central portion of a cross section of the pressure welded part) (test pieces T1, T2, T3), it can be assumed that the strength of the pressure welded part as the pressure welded material can be sufficiently secured.

For the confirmation, although not listed as test data, other five test pieces were prepared in addition to T1 to T5 in the same condition (the pressure welding method according to the present invention) as the pressure welding fracture test 1 and were each subjected to a tensile fracture test. As a result, all of the five pieces underwent a fracture of the base material, and a sufficient strength of the pressure welded part was observed although the test was a simulated one which did not verify the flat fracture surface.

### Pressure Welding Fracture Test 2

In this pressure welding fracture test, in order to confirm that the combination of the air blocking ring 2, the reduction sheet 3, and the reduction ring 5 of the polymeric reduction material for gas pressure welding A1 according to the present invention has an advantage in that the flat fracture surface generated on the pressure welded surface is less likely to occur in the central portion of the fracture surface, the pressure welding fracture test 1 and a pressure welding fracture test 2 shown in FIG. 5 were compared.

In the pressure welding fracture test 2, only an air blocking ring (not shown) having the same structure as the above air blocking ring 2 was sandwiched between pressure welded surfaces 40 of deformed reinforcing bars 4, and the deformed reinforcing bars 4 were subjected to gas pressure welding, notched and fractured to prepare test pieces T6 to T10, and a flat fracture surface 7 on a fracture surface of each test piece was verified.

In the pressure welding fracture test 2 shown in FIG. 5, the flat fracture surface 7 was generated on all fracture surfaces of the test pieces T6 to T10 in which cut portions C have a half-moon shape. First, the flat fracture surface 7 generated on the test piece T6 was observed at a place from a lower edge portion to the vicinity of the central portion of the fracture surface excluding the cut portion C. The flat fracture surface 7 generated on the test piece T7 was observed at a place from the central portion to an upper edge portion of the fracture surface.

The flat fracture surface 7 generated on the test piece T8 was observed at a place from the central portion to the lower edge portion of the lower portion of the fracture surface. The flat fracture surface 7 generated on the test piece T9 was observed along a diametrical direction of an upper portion and the lower portion of the fracture surface. Further, the flat fracture surface 7 generated on the test piece T10 was observed from the central portion to a peripheral edge portion of the upper portion of the fracture surface.

### Discussion

The flat fracture surfaces 7 of the test pieces T6 to T10 are all such that a part thereof was positioned in or near the central portion of the fracture surface. Therefore, as described above, considering the point that the fatigue strength is said to be reduced when a large number of flat fracture surfaces are generated in the vicinity of the central portion of the fracture surface of the material, it is difficult to assume that the strength of the pressure welded part as the pressure welded material is sufficiently secured.

For confirmation, although not listed as test data, five other test pieces were prepared in addition to T6 to T10 in the same condition as the pressure welding fracture test 2 and were each subjected to a tensile fracture test. As a result, only one piece underwent a fracture of the base material, and the others underwent a fracture of the pressure welded surface. That is, although the test was a simulated one which did not verify a flat fracture surface, it can be assumed that the strength of the pressure welded part is not sufficient in the pressure welding performed with only the air blocking ring sandwiched.

As just described, in each test piece obtained by the gas pressure welding method using the polymeric reduction material for gas pressure welding A1 according to the present invention, the effect of suppressing the generation of the flat fracture surface in the central portion of the fracture surface has been seen as compared with the test pieces obtained by using only the air blocking ring as the antioxidant means. In this regard, it has been clarified that there is an advantage in combining the air blocking ring 2, the reduction sheet 3, and the reduction ring 5, but not the air blocking ring alone made of a polyimide resin.

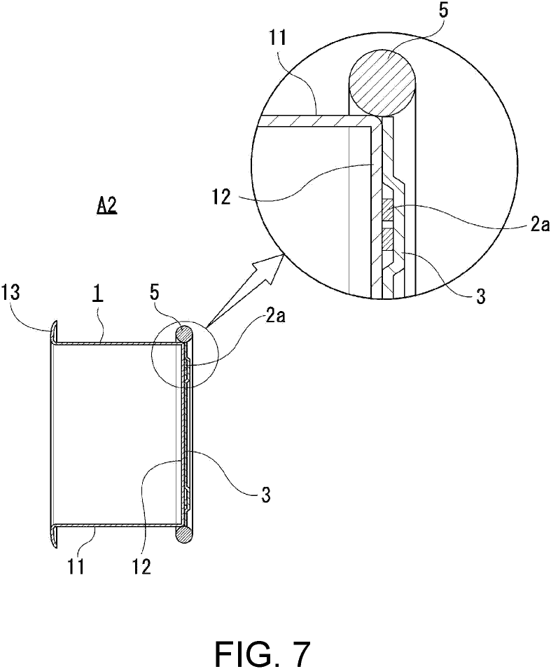

Reference is made to FIG. 6 and FIG. 7.

A polymeric reduction material for gas pressure welding A2 according to the present invention has a cap body 1. The cap body 1 is made of a sheet made of a polystyrene resin. The cap body 1 is composed of a cylindrical portion 11 and a circular bottom portion 12 closing a proximal end portion of the cylindrical portion 11. A tip portion of the cylindrical portion 11 is provided with a reinforcing flange 13 over the entire circumference.

The cap body 1 is such that the bottom portion 12 and a reduction sheet 3 are welded with an air blocking ring 2a sandwiched therebetween to be thermally deformed and the air blocking ring 2a is enclosed (see the enlarged view of FIG. 7). The air blocking ring 2a is made of a polyimide resin and has a spiral shape in which both end portions are overlapped on inner and outer sides by a predetermined length. A reduction ring 5 made of a polyimide resin is wound around an outer peripheral portion of a stacked portion of the air blocking ring 2a, the bottom portion 12 serving as the reduction sheet, and the reduction sheet 3.

The inner diameter of the cylindrical portion 11 of the cap body 1 is formed to have an appropriate size so as not to have looseness, difficulty in insertion, etc., in accordance with the outer diameter of the deformed reinforcing bar or the like to be the material to be pressure welded. When the cap body 1 is fitted into the material to be pressure welded, the air blocking ring 2a fits in the center of a pressure welded surface 40 of the material to be pressure welded and the bottom portion 12 abuts against the pressure welded surface 40.

The thickness of the air blocking ring 2a and the thickness of the bottom portion 12 and the reduction sheet 3 are the same as those of the air blocking ring 2, the bottom portion 12, and the reduction sheet 3 of the above polymeric reduction material for gas pressure welding A1. The heat resistance performance and characteristics of the air blocking ring 2a and the heat resistance performance and characteristics of the bottom portion 12 and the reduction sheet 3 are also the same as those of the air blocking ring 2, and the bottom portion 12 and the reduction sheet 3.

The material of the cap body 1 of the polymeric reduction material for gas pressure welding A2 is not limited to the polystyrene resin, and various resins can be appropriately employed as long as it is a thermoplastic resin such as polyethylene (PE) or polypropylene (PP). The material of the air blocking ring 2a is not limited to the polyimide resin, and various resins can be appropriately employed as long as it is a thermosetting resin such as silicon.

The polymeric reduction material for gas pressure welding A2 has almost the same structure as the polymeric reduction material for gas pressure welding A1 with the only difference between the air blocking ring 2a and the air blocking ring 2. Therefore, regarding the use and operation of the polymeric reduction material for gas pressure welding A2, the description of the operation of the polymeric reduction material for gas pressure welding A1 is incorporated for the portion in common with the polymeric reduction material for gas pressure welding A1, and only differences will be described.

The polymeric reduction material for gas pressure welding A2 has the air blocking ring 2a having a spiral shape in which both end portions are overlapped on the inner and outer sides by a predetermined length, so that the heated and pressed air blocking ring 2a is crushed and expanded, and in particular, “the portions where both end portions are overlapped on inner and outer sides by a predetermined length” are crimped to each other and a ventilation portion is closed at an early stage. Furthermore, at least the crimped portion has a wide width and a high density.

Therefore, it can be assumed that, in a situation where the air blocking ring 2a is sandwiched between the pressure welded surfaces 40 of the deformed reinforcing bars 4 at a specified pressure, the strength increases as compared with the air blocking ring 2 of the polymeric reduction material for gas pressure welding A1 and the timing at which the air blocking ring 2a is heated and carbonized to be fractured is slightly delayed. Accordingly, the pressure of the air blown out to the outside is further increased, and the effect of suppressing the oxidation around the pressure welded part 400 is further enhanced.

The terms and expressions used in the description and the claims are only for the purpose of description and are not limiting, and there is no intention to exclude terms and expressions equivalent to the features and a part thereof described in the description and the claims. It is obvious that various modifications can be made within the scope of the technical idea of the present invention.

DESCRIPTION OF REFERENCE NUMERALS

| | |
|---|---|
| A1 | Polymeric reduction material for gas pressure welding |
| 1 | Cap body |
| 11 | Cylindrical portion |
| 12 | Bottom portion |
| 13 | Flange |
| 2 | Air blocking ring |
| 3 | Reduction sheet |
| 4 | Deformed reinforcing bar |
| 40 | Pressure welded surface |
| 400 | Pressure welded part |
| 5 | Reduction ring |
| 6 | Gas burner |
| A2 | Polymeric reduction material for gas pressure welding |
| 2 a | Air blocking ring |
| T1 to T5 | Test piece |
| T6 to T10 | Test piece |
| 7 | Flat fracture surface |
| C | Cut portion |

What is claimed is:

1. A polymeric reduction material for gas pressure welding comprising:
an air blocking ring that can be arranged between pressure welded surfaces of materials to be pressure welded, is made of a thermosetting resin, and has a required diameter;
a reduction sheet that is stacked so as to be positioned on one side of the air blocking ring or stacked so as to sandwich the air blocking ring from both front and rear sides, and has a diameter equal to or larger than that of the air blocking ring and is made of a thermoplastic resin; and
a string-shaped or band-shaped reduction ring that is wound apart from the air blocking ring around an outer peripheral portion on the same plane as a stacked portion of the air blocking ring and the reduction sheet and is made of a thermosetting resin.

2. The polymeric reduction material for gas pressure welding according to claim 1, further comprising a cap body that is made of a thermoplastic resin, can be externally fitted to a pressure welded-side end portion of the material to be pressure welded, and is a bottomed cylindrical body, wherein the air blocking ring is integrally provided at a bottom portion of the cap body.

3. The polymeric reduction material for gas pressure welding according to claim 1, wherein the air blocking ring is formed in a spiral shape in which both end portions are overlapped on inner and outer sides by a predetermined length.

4. The polymeric reduction material for gas pressure welding according to claim 1, wherein the air blocking ring is made of a polyimide resin and the reduction sheet is made of a polystyrene resin.

5. The polymeric reduction material for gas pressure welding according to claim 1, wherein the reduction sheet has a total thickness of 0.17 to 2.55 mm.

6. A gas pressure welding method comprising:
a step of arranging a polymeric reduction material for gas pressure welding by stacking, between pressure welded surfaces of materials to be pressure welded, an air blocking ring that is made of a thermosetting resin and has a required diameter and a reduction sheet that is positioned on one side of the air blocking ring or sandwiches the air blocking ring from both front and rear sides, and has a diameter equal to or larger than that of the air blocking ring and is made of a thermoplastic resin, and by winding a string-shaped or band-shaped reduction ring made of a thermosetting resin apart from the air blocking ring around an outer peripheral portion on the same plane of a stacked portion of the air blocking ring and the reduction sheet; and
a step of heating a pressure welded part of the materials to be pressure welded by thermal power of a required gas while applying a predetermined pressure to each of the materials to be pressure welded in a direction in which pressure welded surfaces of the materials to be pressure welded are brought into close contact with each other.

7. The gas pressure welding method according to claim 6, wherein the air blocking ring is formed in a spiral shape in which both end portions are overlapped on inner and outer sides by a predetermined length.

8. The gas pressure welding method according to claim 6, wherein the air blocking ring is made of a polyimide resin and the reduction sheet is made of a polystyrene resin.

9. The gas pressure welding method according to claim 6, wherein the gas is propane gas and heating is performed with a standard flame from an initial stage of heating.
